(19) United States
(12) Patent Application Publication
(10) Pub. No.: US 2026/0073257 A1
(43) Pub. Date: Mar. 12, 2026

(54) DISTRIBUTED AI AGENT FRAMEWORK

(71) Applicant: Cisco Technology, Inc., San Jose, CA (US)

(72) Inventors: Oliver James Bull, Portishead (GB); Frank Bachet, Breval (FR); Reinaldo Penno Filho, San Ramon, CA (US); Hendrikus G.P. Bosch, Amstelveen (NL)

(73) Assignee: Cisco Technology, Inc., San Jose, CA (US)

(21) Appl. No.: 19/095,650

(22) Filed: Mar. 31, 2025

Related U.S. Application Data
(60) Provisional application No. 63/693,486, filed on Sep. 11, 2024.

(51) Int. Cl. G06N 5/043; G06F 16/901

(52) U.S. Cl. CPC G06N 5/043; G06F 16/9024

(57) ABSTRACT

In one implementation, a device that executes a first artificial intelligence agent receives a request to perform a task. The device obtains a manifest that represents capabilities of a second artificial intelligence agent. The first artificial intelligence agent selects the second artificial intelligence agent to perform a portion of the task, by inputting the manifest and an indication of the task as input to an artificial intelligence model. The first artificial intelligence agent sends a request to the second artificial intelligence agent to perform the portion of the task.

### RELATED APPLICATION

This application claims priority to U.S. Prov. Appl. Ser. No. 63/693,486, filed Sep. 11, 2024, entitled “DISTRIBUTED AI AGENT FRAMEWORK” by Bull, et al., the contents of which are incorporated herein by reference.

### TECHNICAL FIELD

The present disclosure relates generally to computer networks and more particularly to a distributed artificial intelligence (AI) agent framework.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

Modern applications tend to be a composition of multiple components and services distributed across multiple locations. In contrast, applications built using agent-based frameworks such as LangGraph are monolithic in nature. This means that they cannot be distributed to best meet performance, scale, or policy requirements.

In addition, LLM-based artificial intelligence (AI) agent frameworks today have mechanisms to control execution flow, state management context definition, and tool selection. These frameworks (e.g., LangGraph) create a compiled runnable system to perform a specific task. This is fixed at the point of compilation and therefore are creates a static instance. This creates challenges when creating more complex agents with multiple functional graphs stitched together with dedicated edges to join clusters of nodes together. Moreover, when one agent wants to interact with another agent, there is no defined method for how this could occur between the agent frameworks and LLM functionalities.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of interfacing with a generative model;

FIG. 4 illustrates an example architecture for the interaction of artificial intelligence (AI) agents;

FIG. 5 illustrates an example architecture for the interaction of distributed AI agents;

FIG. 6 illustrates an example architecture 600 for the interaction of distributed AI agents via a communication interface;

FIG. 7 illustrates an example of an agent client tool, and

FIG. 8 illustrates an example procedure for distributed AI agent communications, in accordance with one or more implementations described herein.

### DESCRIPTION OF EXAMPLE IMPLEMENTATIONS

### Overview

According to one or more implementations of the disclosure, a device that executes a first artificial intelligence agent receives a request to perform a task. The device obtains a manifest that represents capabilities of a second artificial intelligence agent. The first artificial intelligence agent selects the second artificial intelligence agent to perform a portion of the task, by inputting the manifest and an indication of the task as input to an artificial intelligence model. The first artificial intelligence agent sends a request to the second artificial intelligence agent to perform the portion of the task.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

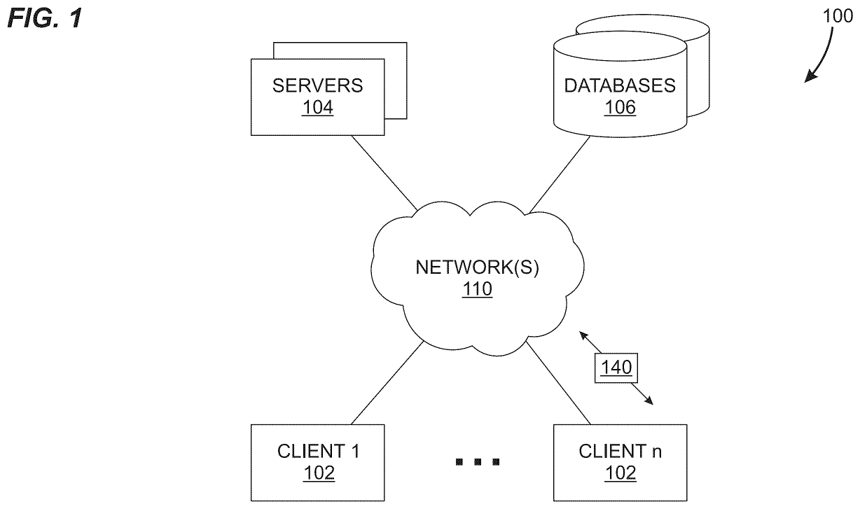

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

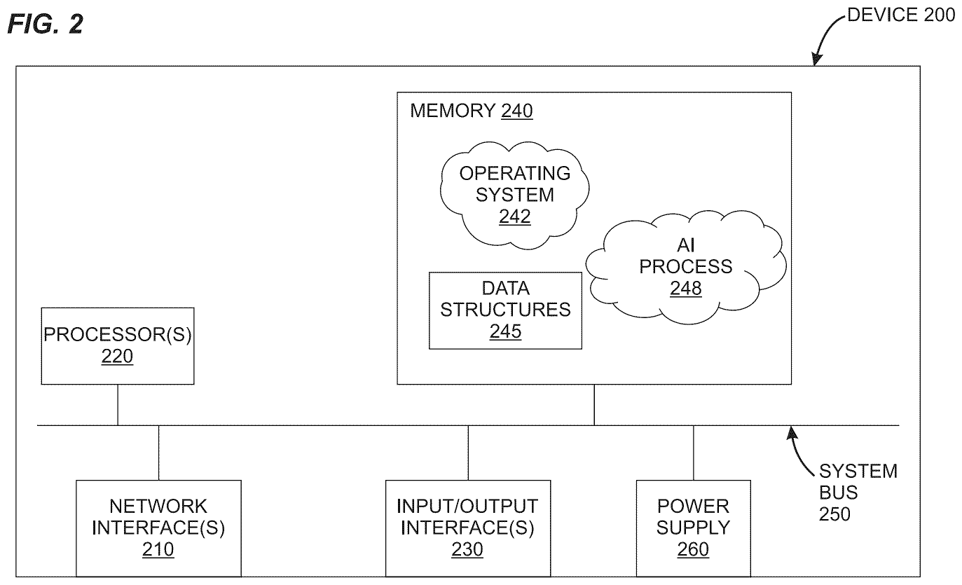

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs), other transformer models, and the like.

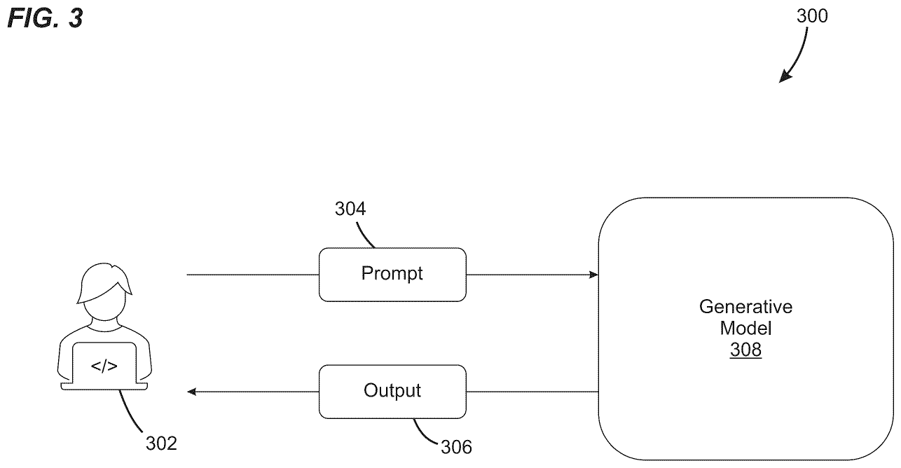

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

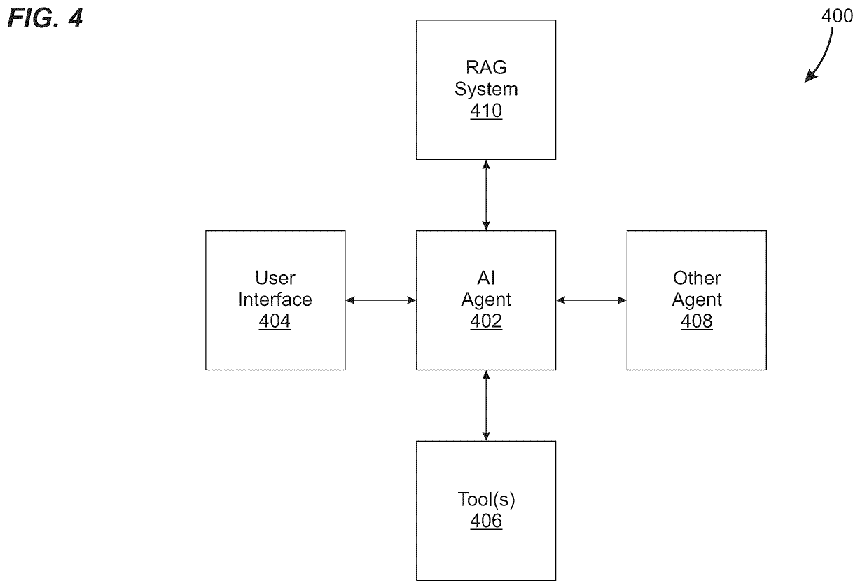

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, AI agents can be written to perform complex tasks by chaining multiple calls to one or more LLMs, often mimicking the interactions of a user and an LLM, such as user 302 and generative model 308. For example, a first step can consist in formulating a plan in natural language, and subsequent steps in executing on this plan by writing code to call application programming interfaces (APIs) or libraries.

LLM-based AI systems (e.g., using OpenAI GPT4x) support the ability to specify a list of tools as functions that the LLM can call if it decides that doing so can aid it in addressing the question being posed. When an agentic framework (e.g., LangGraph) is overlaid, these tools can perform specific tasks to assist the agent with its requirements. For instance, one tool may run a search engine query to obtain additional information.

When an AI agent is decomposed into performing specific single tasks (which is good design practice), they exist as a component that is part of a bigger composition of agents working together. However, joining independent, distributed agents together to create a distributed network of agents to perform the required task remains challenging.

### Distributed Artificial Intelligence (AI) Agent Framework

The techniques introduced herein allow distributed AI agents to communicate (e.g., machine-to-machine) through tool calls that abstract remote agents for calling agents to invoke. By doing so, the calling agent thinks only of tools through the tool manifest while the agent client tool implements the specific agent calling method to the remote agent.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device that executes a first artificial intelligence agent receives a request to perform a task. The device obtains a manifest that represents capabilities of a second artificial intelligence agent. The first artificial intelligence agent selects the second artificial intelligence agent to perform a portion of the task, by inputting the manifest and an indication of the task as input to an artificial intelligence model. The first artificial intelligence agent sends a request to the second artificial intelligence agent to perform the portion of the task.

Operationally, the techniques herein allow one AI agent to call another agent using callable tools as an abstraction, according to various implementations. The capabilities of an agent are encapsulated in the tool description and presented as an agent ‘manifest’ that can be consumed by another agent. In general, the manifest of an agent describes its capabilities and functions, as described further below. These tools are then passed to an embedded LLM or other generative model through a framework for selection as required, based on the task that the primary agent is seeking to perform. Using a “client tool” to abstract another agent creates a mechanism to step into an alternate agent without needing to know the full details of operation. This alternate agent is a separate entity which means it can be ether locally or remotely running.

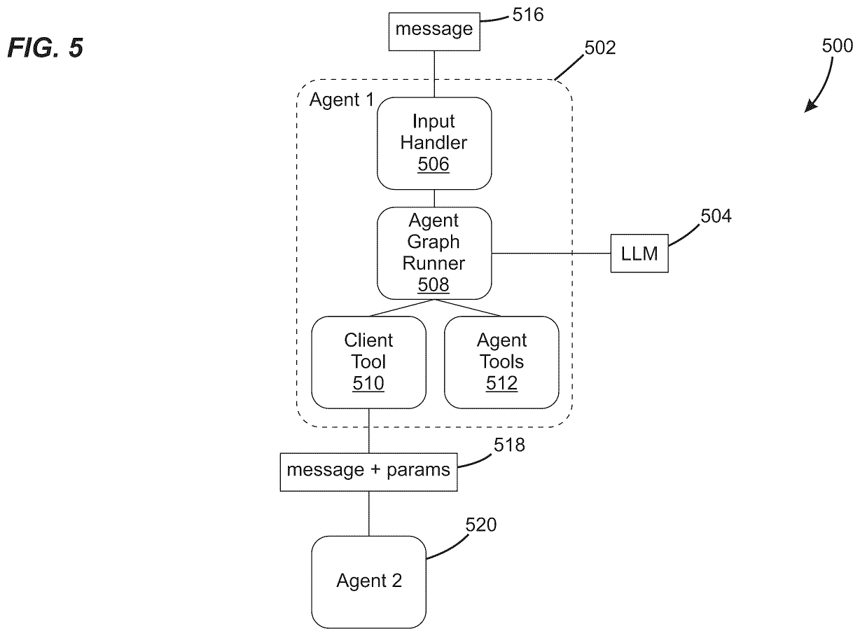

More specifically, FIG. 5 illustrates an example architecture 500 for the interaction of AI agents, according to various implementations. As shown, agent 502 (i.e., a first AI agent) may comprise any or all of the following components (e.g., through execution of AI process 248): an input handler 506, an agent graph runner 508, client tool 510, and/or agent tools 512.

During execution, agent 502 may receive an input message 516, such as from a user or another system or machine. In turn, input handler 506 passes input message 516 to agent graph runner 508 (e.g., LangGraph) which interacts with LLM 504 based on the specified graph.

With respect to the tools available to agent 502, these may fall into two categories: agent-specific tools, such as agent tools 512, and/or client-specific tools associated with other agents, such as client tool 510. For instance, assume that agent 502 is in communication with agent 520 (i.e., a second AI agent). In such a case, client tool 510 may represent the actions that agent 520 is capable of performing, which can be an important factor for agent selection by LLM 504. In some implementations, each agent in the system may be described by a corresponding agent “manifest,” as detailed further below.

Typically, an agent manifest includes details such as any or all of the following: the functionality offered by the agent, the name of the agent, input/output data and parameters consumed and produced by the agent, interfaces and protocols supported by the agent, the reputation and performance of the agent, methods for observability, security, authentication, etc. The manifests of the available agents allow agent 502 (via the LLMs it uses, such as LLM 504, and additional decision logic) to resolve overlap between alternate agents, e.g., by narrowing down separate lines of responsibility or by selecting a single agent based on, e.g., the reputation or performance of the agent.

Once selected, LLM 504 may populate the parameters defined as part of the agent manifest via client tool 510. Agent 502 may then pass these parameters on to the selected agent, such as agent 520 for invocation. These messages and parameters 518 can be pass through, modified, augmented, or generated, depending on the functionality of agent 520.

In one implementation of this approach, there is a fixed relationship between the client tool 510 and the called agent, such as agent 520. Client tool 510 represents exactly one alternate agent to the calling agent and its LLM (e.g., depending on the manifest used for the specific instance of client tool 510).

In another implementation, architecture 500 may support multiple alternate agents where there is some overlap among the capabilities of the agents. All of the agents may be presented as a single manifest to the calling agent. In such cases, client tool 510 may also have its own logic to select which agent to use based on its own logic or as directed by the LLM via the options specified in the manifest.

Note that there can also be several instances of client tool 510 in a single deployment of an agent, such as agent 502, where each client tool 510 represents one or multiple manifests of alternate remote agents. Moreover, further parameters can be presented to the agent through the agent manifest to permit options such as any or all of the following:
Session management (either create a new session for each alternate agent call or reuse an already existing session for the alternate agent call).
Memory retention (instruct the alternate agent to keep memory from early invocations for the same session or not).
Re-entrant behavior of the alternate agent.

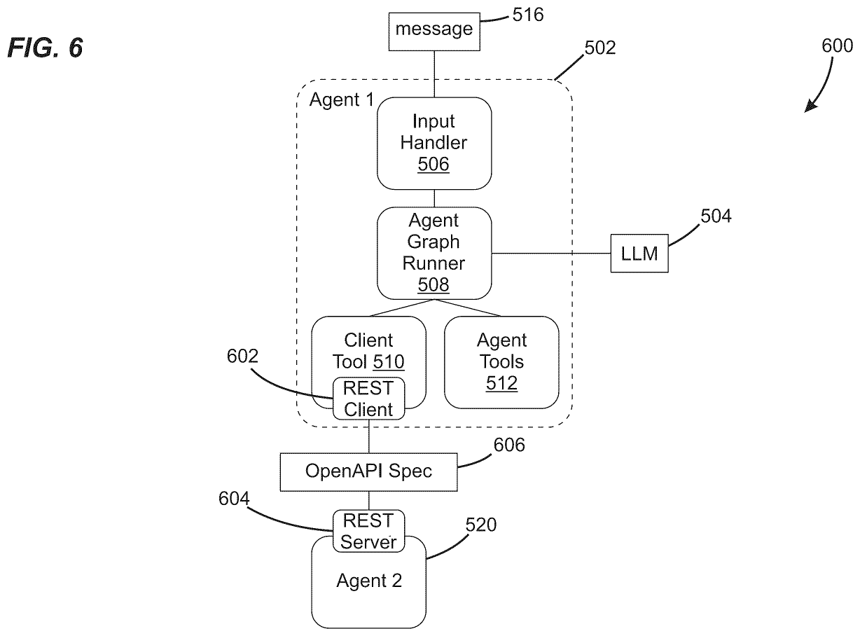

FIG. 6 illustrates an example architecture 600 for the interaction of distributed AI agents via a communication interface, according to various implementations. As would be appreciated, architecture 600 demonstrates an extension of architecture 500 where the agents, agent 502 and agent 520, are separated by a communication interface, such as a Representational State Transfer (REST) interface. In such cases, client tool 510 may present the same manifest to agent graph runner 508, but the calling approach takes the form of a microservice interface using the REST Open API specification 606.

More specifically, agent 502 may further include a REST client 602 that communicates with a REST server 604 using the REST Open API specification 606. During operation, REST server 604 may receive the requests and agent 520 may run its own agent graph runner.

As would be appreciated, REST API is just one implementation example. Indeed, architecture 600 could alternately be implemented to use any suitable communication approach between agent 502 and agent 520 such as, but not limited to, Remote Procedure Call (RPC), gRPC, GraphQL, Websockets, Unix Domain Sockets, and the like.

Distributed remote agents allows agentic systems to follow the deployment blueprints of microservice applications. Moreover, each agent can now be containerized to create a cloud-native microservices architecture leveraging all existing modes of operation for deployment lifecycles and observability. This also creates a future environment where these agents are discoverable and callable in a similar way to existing published APIs and software development kits (SDKs), but the service being called is an agent called by another agent (machines talking to machines).

In further implementations, the above mechanism for distributed agents, such as agent 502 and agent 520, can also operate in an iterative way, in that an alternate second agent might invoke a further third agent, and so forth. Similarly, agent 520 may also decide to call agent 502 again, to perform iterations.

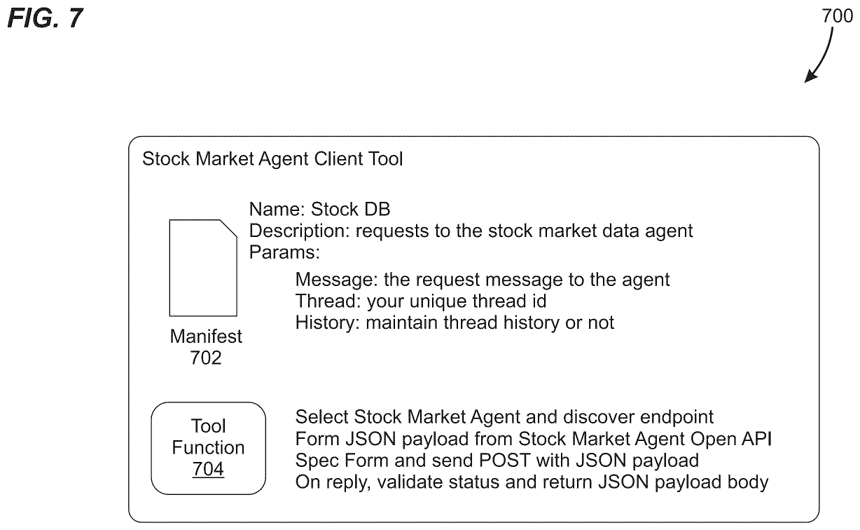

FIG. 7 illustrates an example of an agent client tool 700, in various implementations. Continuing the above examples, client tool 510 may take the form of agent client tool 700, in some implementations. Here, for instance, assume that agent 520 takes the form of an AI agent associated with the stock market. In such a case, its corresponding manifest 702 in agent client tool 700 may include information about agent 520 such as its name, description, parameters (e.g., message, thread, history, etc.), or the like.

Similarly, agent client tool 700 may also include tool function information 704, such as the ability to select a stock market agent and discover an endpoint, form a JSON payload from the stock market agent using the Open API specification, form and send POST information with the JSON payload, and/or on reply, validate the status and return the JSON payload body.

In summary, the techniques herein provide for the following capabilities, among others:
Abstracting the functionality of an AI agent as a tool method for another agent to call.
Creating an environment where AI agents can call other AI agents without knowledge that the remote entity is an AI agent.
Defining an agent ‘manifest’ to describe the remote agent including agent specifics such as functionality, name, input parameters, and output results.
With an extension to items such as the reputation and performance of the agent, methods for observability, security, and/or authentication.
Allowing the ‘manifest’ to be both tightly coupled to the receiving agent and loosely descriptive to integrate with the calling agent.
Creating a 1:1 and 1:many calling model whereby the selected remote agent is resolved within the agent abstraction tool.
Agents can operate remotely with this abstraction through alternate transport mechanisms (e.g., REST service as a front end to the agent).
Allowing the ‘manifest’ to hold extended information such as popularity, and security.
Agent responses must be managed at the point of calling to guide the agent's reply.

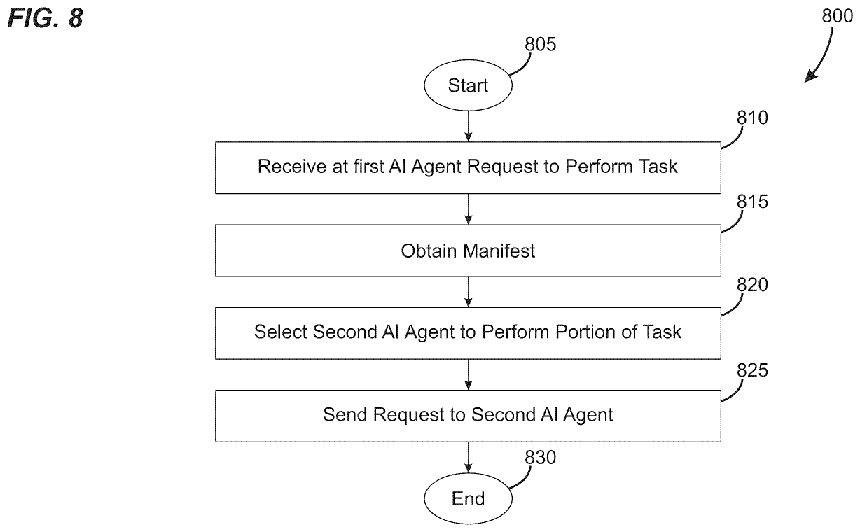

FIG. 8 illustrates an example of a simplified procedure for distributed AI agent communications, in accordance with one or more implementations described herein. For example, a non-generic, specifically configured device (e.g., device 200), may perform procedure 800 (e.g., a method) by executing stored instructions (e.g., AI process 248). The procedure 800 may start at step 805, and continues to step 810, where, as described in greater detail above, the device (e.g., a controller, server, etc.) may receive, at a first artificial intelligence agent executed by the apparatus, a request to perform a task.

At step 815, as detailed above, the device may obtain, by the first artificial intelligence agent, a manifest that represents capabilities of a second artificial intelligence agent. In various implementations, the artificial intelligence model comprises a large language model (LLM). In some implementations, the first artificial intelligence agent obtains the manifest via a microservice communication interface. In some instances, the manifest indicates at least one of: an input of the second artificial intelligence agent, an output of the second artificial intelligence agent, an interface supported by the second artificial intelligence agent, or a protocol supported by the second artificial intelligence agent. In further instances, the manifest indicates at least one of: a reputation of the second artificial intelligence agent, a level of performance of the second artificial intelligence agent, security of the second artificial intelligence agent, or authentication used by the second artificial intelligence agent.

At step 820, the device may select, by the first artificial intelligence agent inputting the manifest and an indication of the task as input to an artificial intelligence model, the second artificial intelligence agent to perform a portion of the task, as described in greater detail above. In one implementation, the first artificial intelligence agent represents the task as a graph. In some implementations, the first artificial intelligence agent selects the second artificial intelligence agent to perform the portion of the task from among a set of artificial intelligence agents. In one implementation, the manifest is indicative of the capabilities of each of the set of artificial intelligence agents and there is an overlap in their capabilities.

At step 825, as detailed above, the device may send, by the first artificial intelligence agent, a request to the second artificial intelligence agent to perform the portion of the task. In one implementation, the first artificial intelligence agent represents the second artificial intelligence agent as an available client tool without an indication that it is an agent. In a further implementation, in the second artificial intelligence agent is executed by a second device.

Procedure 800 may then end at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
receiving, at a device that executes a first artificial intelligence agent, a request to perform a task;
obtaining, by the device, a manifest that represents capabilities of a second artificial intelligence agent;
selecting, by the first artificial intelligence agent inputting the manifest and an indication of the task as input to an artificial intelligence model, the second artificial intelligence agent to perform a portion of the task; and
sending, by the first artificial intelligence agent, a request to the second artificial intelligence agent to perform the portion of the task.

2. The method as in claim 1, wherein the artificial intelligence model comprises a large language model (LLM).

3. The method as in claim 1, wherein the first artificial intelligence agent obtains the manifest via a microservice communication interface.

4. The method as in claim 1, wherein the first artificial intelligence agent represents the task as a graph.

5. The method as in claim 1, wherein the manifest indicates at least one of: an input of the second artificial intelligence agent, an output of the second artificial intelligence agent, an interface supported by the second artificial intelligence agent, or a protocol supported by the second artificial intelligence agent.

6. The method as in claim 1, wherein the manifest indicates at least one of: a reputation of the second artificial intelligence agent, a level of performance of the second artificial intelligence agent, security of the second artificial intelligence agent, or authentication used by the second artificial intelligence agent.

7. The method as in claim 1, wherein the first artificial intelligence agent selects the second artificial intelligence agent to perform the portion of the task from among a set of artificial intelligence agents.

8. The method as in claim 7, wherein the manifest is indicative of the capabilities of each of the set of artificial intelligence agents, and wherein there is an overlap in their capabilities.

9. The method as in claim 1, wherein the first artificial intelligence agent represents the second artificial intelligence agent as an available client tool without an indication that it is an agent.

10. The method as in claim 1, wherein the second artificial intelligence agent is executed by a second device.

11. An apparatus, comprising:
one or more network interfaces;
a processor coupled to the one or more network interfaces and configured to execute one or more processes; and
a memory configured to store a process that is executable by the processor, the process when executed configured to:
receive, at a first artificial intelligence agent executed by the apparatus, a request to perform a task;
obtain, by the first artificial intelligence agent, a manifest that represents capabilities of a second artificial intelligence agent;
select, by the first artificial intelligence agent inputting the manifest and an indication of the task as input to an artificial intelligence model, the second artificial intelligence agent to perform a portion of the task; and
send, by the first artificial intelligence agent, a request to the second artificial intelligence agent to perform the portion of the task.

12. The apparatus as in claim 11, wherein the artificial intelligence model comprises a large language model (LLM).

13. The apparatus as in claim 11, wherein the first artificial intelligence agent obtains the manifest via a microservice communication interface.

14. The apparatus as in claim 11, wherein the first artificial intelligence agent represents the task as a graph.

15. The apparatus as in claim 11, wherein the manifest indicates at least one of: an input of the second artificial intelligence agent, an output of the second artificial intelligence agent, an interface supported by the second artificial intelligence agent, or a protocol supported by the second artificial intelligence agent.

16. The apparatus as in claim 11, wherein the manifest indicates at least one of: a reputation of the second artificial intelligence agent, a level of performance of the second artificial intelligence agent, security of the second artificial intelligence agent, or authentication used by the second artificial intelligence agent.

17. The apparatus as in claim 11, wherein the first artificial intelligence agent selects the second artificial intelligence agent to perform the portion of the task from among a set of artificial intelligence agents.

18. The apparatus as in claim 17, wherein the manifest is indicative of the capabilities of each of the set of artificial intelligence agents, and wherein there is an overlap in their capabilities.

19. The apparatus as in claim 11, wherein the first artificial intelligence agent represents the second artificial intelligence agent as an available client tool without an indication that it is an agent.

20. A tangible, non-transitory, computer-readable medium storing program instructions that cause a device to execute a process comprising:
receiving, at the device, a request to perform a task;
obtaining, by a first artificial intelligence agent executed by the device, a manifest that represents capabilities of a second artificial intelligence agent;
selecting, by the first artificial intelligence agent inputting the manifest and an indication of the task as input to an artificial intelligence model, the second artificial intelligence agent to perform a portion of the task; and
sending, by the first artificial intelligence agent, a request to the second artificial intelligence agent to perform the portion of the task.
